(19) United States
(12) Patent Application Publication
(10) Pub. No.: US 2015/0197111 A1
(43) Pub. Date: Jul. 16, 2015

(54) MOUNTING ASSEMBLY FOR A PRINTER

(71) Applicant: DUALITY FOCUS COMPANY LIMITED, BELIZE CITY (BZ)

(72) Inventors: SEE-HING TIANG, CITY OF INDUSTRY, CA (US); KHAIRIL SINGGIH, CITY OF INDUSTRY, CA (US)

(73) Assignee: DUALITY FOCUS COMPANY LIMITED, BELIZE CITY (BZ)

(21) Appl. No.: 14/154,316

(22) Filed: Jan. 14, 2014

(51) Int. Cl. B41J 29/02

(52) U.S. Cl. CPC B41J 29/02

(57) ABSTRACT

A mounting assembly for a printer has an upper housing, a base cover mounted under the upper housing, and a connecting seat. A mounting chamber is defined between the base cover and the upper housing. The printer is mounted on the connecting seat and is mounted into the mounting chamber together with the connecting seat, such that the printer and the connecting seat are packaged by the upper housing and the base cover. The mounting assembly and the printer can be mounted in an installation chamber of a cash register. As the printer and the cash register are assembled together as an integral unit, the printer can be stored easily and space occupied by the printer and the cash register is greatly reduced.

### BACKGROUND OF THE INVENTION

1. Field of the Invention

The present invention relates to a mounting assembly, especially to a mounting assembly for a printer that allows the printer to be connected in conjunction with a cooperating machine.

2. Description of the Prior Art(s)

Printers are widely used output devices and are provided in a variety of types for different purposes. For instance, the printer may cooperate with a cash register and be used to print invoices, the printer may cooperate with a queue management system and be used to print number slips, or the printer may cooperate with a label printer and be used to print labels of products. The label printer is usually disposed in a production line of a factory. However, since each of the above-mentioned printers is separated from its cooperating machine, i.e., the cash register, the queue management system, or the label printer, it is troublesome to store the printer.

With reference to FIG. 7, FIG. 7 shows a cash register 40 and a conventional printer 50. The cash register 40 has a touch screen display 41. The touch screen display 41 is used for displaying and inputting the prices of goods for sale. The conventional printer 50 is electrically connected to the cash register 40 via a transmission cord 51. When the cash register 40 has summed up the prices of the purchased goods, the cash register 40 transmits the transaction information, such as item numbers of the goods, the prices and the like, to the conventional printer 50 through the transmission cord 51, and then the conventional printer 50 prints an invoice or a receipt with the transaction information.

However, since the cash register 40 has to be additionally connected to the conventional printer 50 so as to print the invoices or the receipts, the cash register 40 and the conventional printer 50 occupy large space regardless that the cash register 40 and the conventional printer 50 are disposed side by side or are stacked. Accordingly, storing the cash register 40 and the conventional printer 50 is troublesome. Cords for connecting the cash register 40 and the conventional printer 50 become untidy or messy around the cash register 40.

To overcome the shortcomings, the present invention provides a mounting assembly for a printer to mitigate or obviate the aforementioned problems.

### SUMMARY OF THE INVENTION

The main objective of the present invention is to provide a mounting assembly for a printer. The mounting assembly has an upper housing, a base cover, and a connecting seat. The base cover is mounted under the upper housing to form a mounting chamber defined between the base cover and the upper housing. The base cover has two positioning protrusions and a fastening panel. The positioning protrusions separately protrude up from a rear of the base cover. The fastening panel is formed on a front of the base cover. The connecting seat is mounted in the mounting chamber on the base cover, and has two positioning recesses and a front panel. The positioning recesses are separately formed in a rear of the connecting seat, and respectively correspond in position to and engage the positioning protrusions of the base cover. The front panel is formed on a front of the connecting seat, and corresponds in position to and is detachably attached to the fastening panel of the base cover.

The printer is mounted on the connecting seat and is mounted into the mounting chamber together with the connecting seat, such that the printer and the connecting seat are packaged by the upper housing and the base cover. The mounting assembly and the printer can be mounted in an installation chamber of a cash register. As the printer and the cash register are assembled together as an integral unit, the printer can be stored easily. Space occupied by the printer and the cash register is greatly reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mounting assembly for a printer in accordance with the present invention;

FIG. 2 is an exploded perspective view of the mounting assembly in FIG. 1;

FIG. 3 is a rear perspective view of the mounting assembly in FIG. 1;

FIG. 4 is a rear view of the mounting assembly in FIG. 1;

FIG. 5 is an operational exploded perspective view of the mounting assembly in FIG. 1;

FIG. 6 is an operational perspective view of the mounting assembly in FIG. 1; and

FIG. 7 is a perspective view of a conventional printer connected with a register in accordance with the prior art.

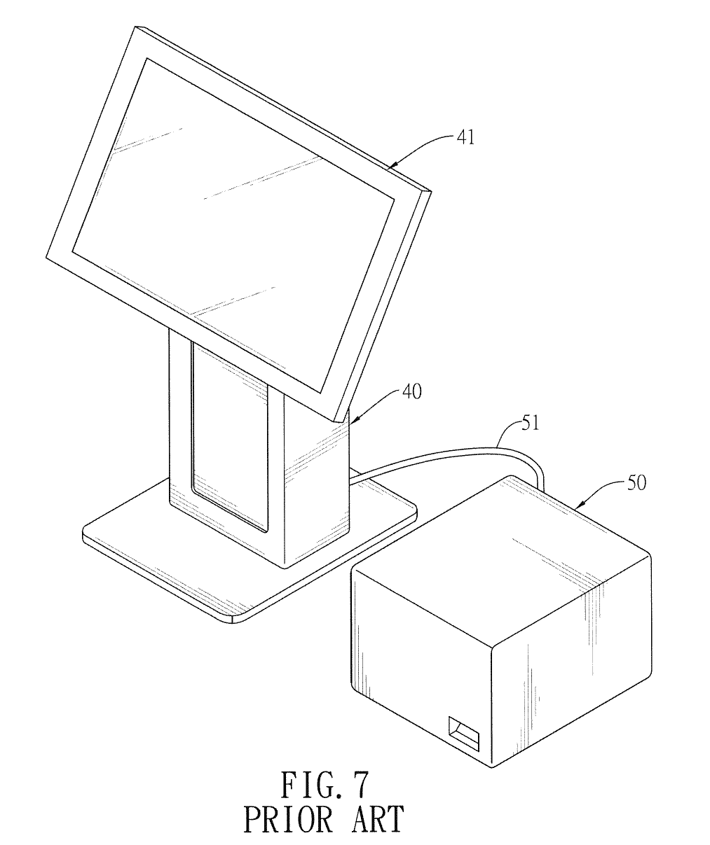

### DETAILED DESCRIPTION OF THE PREFERRED EMBODIMENTS

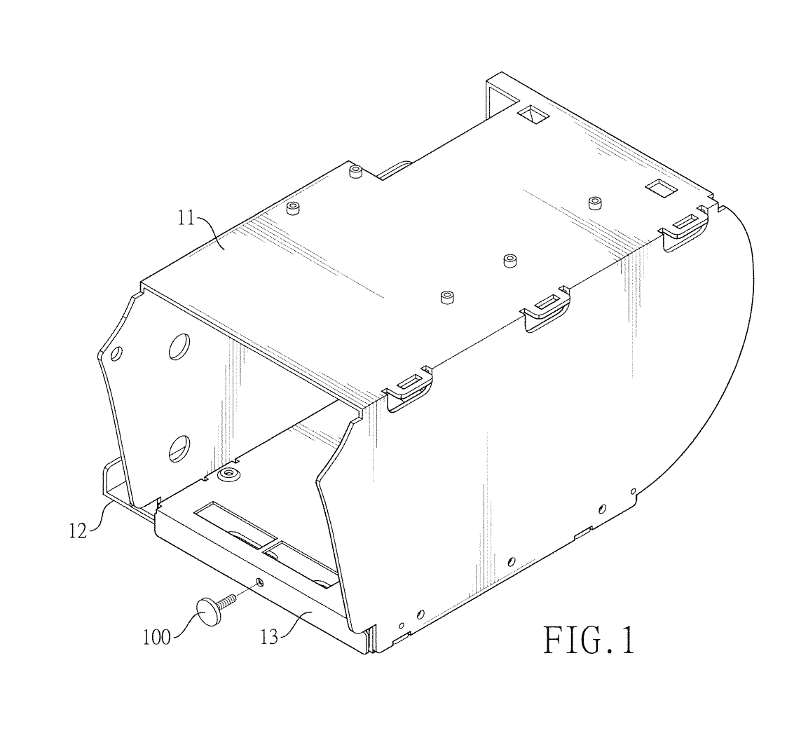

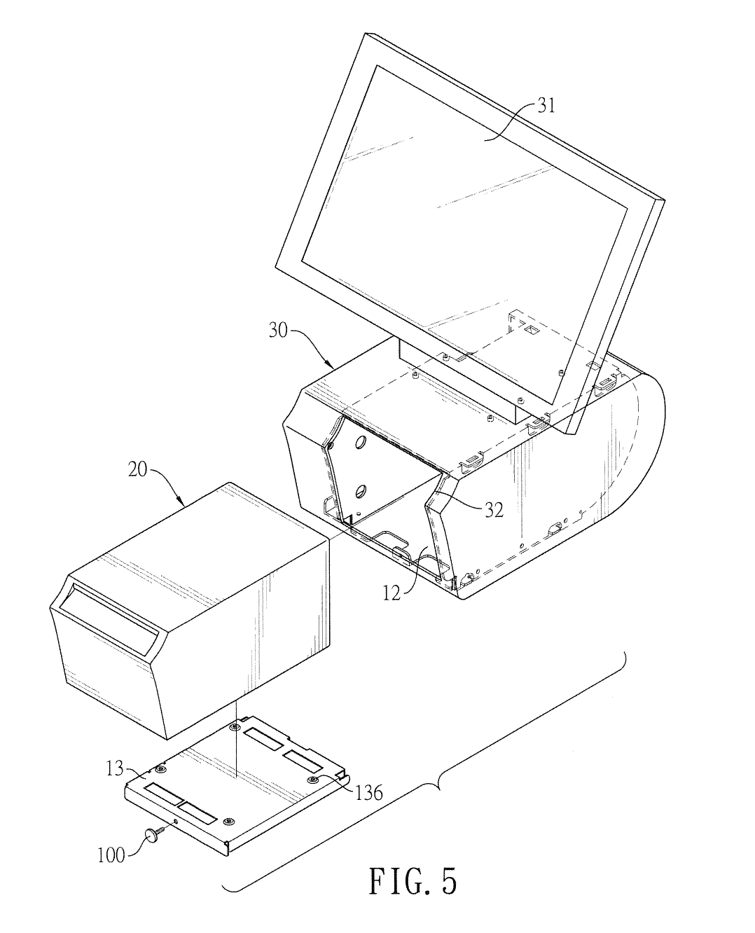

With reference to FIGS. 1 and 5, a mounting assembly for a printer 20 in accordance with the present invention comprises an upper housing 11, a base cover 12, and a connecting seat 13.

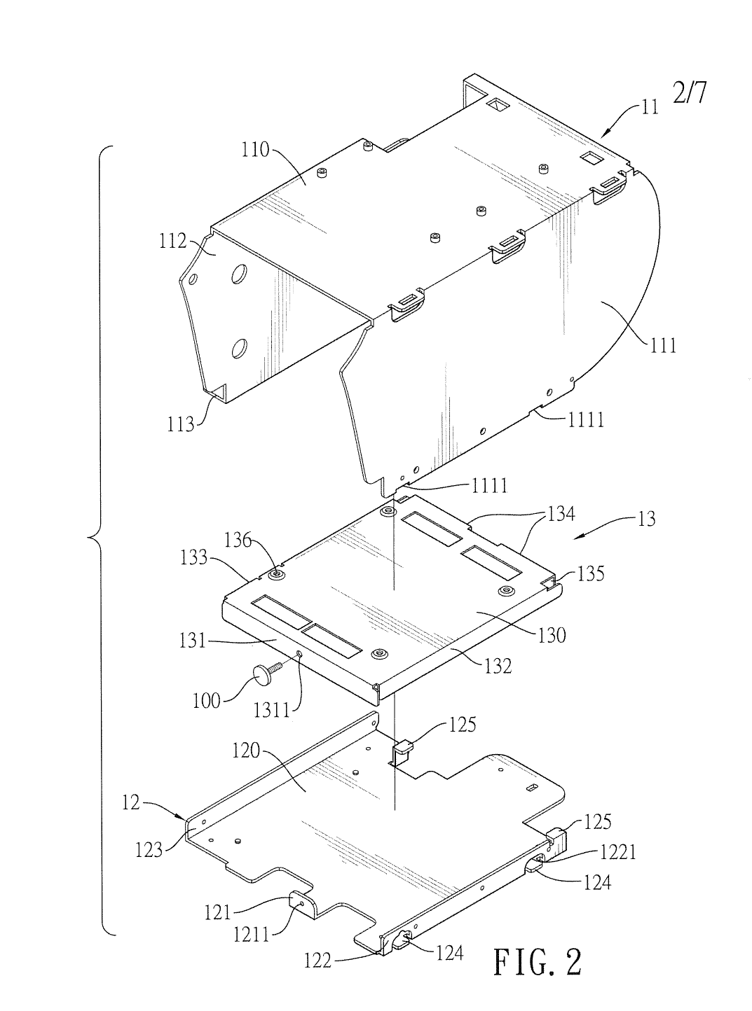

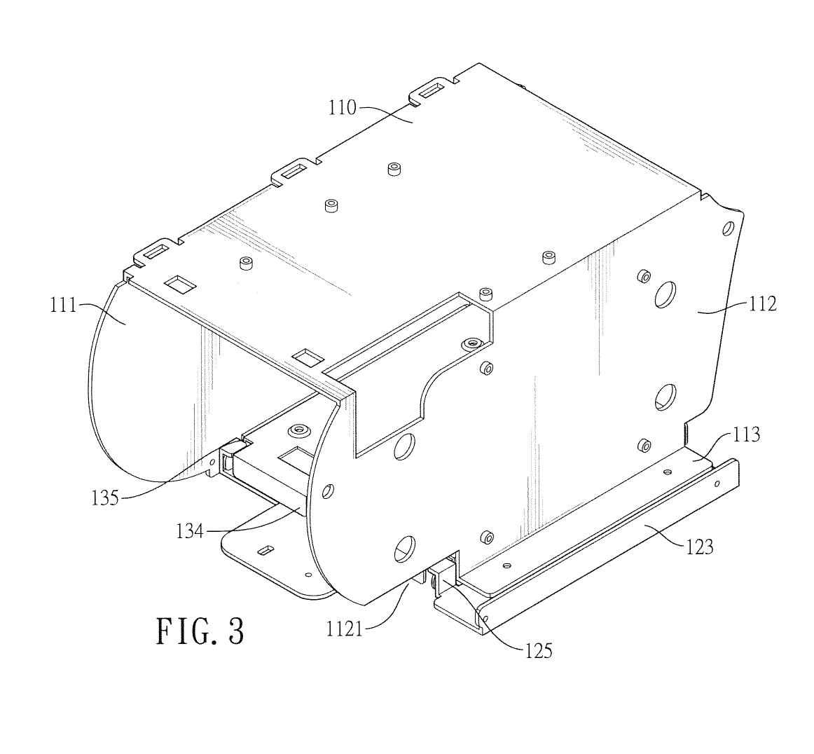

With further reference to FIGS. 2 and 3, the upper housing 11 has a top panel 110, a first side panel 111, a second side panel 112, and an extension panel 113. The top panel 110 is top of the upper housing 11 and has two opposite side edges. The first side panel 111 and the second side panel 112 of the upper housing 11 respectively protrude down from the side edges of the top panel 110. The first side panel 111 of the upper housing 11 has a distal edge and at least one engaging recess 1111. The distal edge of the first side panel 111 of the upper housing 11 is opposite to a corresponding one of the side edges of the top panel 110. The at least one engaging recess 1111 is formed in the distal edge of the first side panel 111 of the upper housing 11. The second side panel 112 of the upper housing 11 has an inner surface, a distal edge, a rear edge, and a mounting recess 1121. The distal edge of the second side panel 112 of the upper housing 11 is opposite to a corresponding one of the side edges of the top panel 110. The mounting recess 1121 is formed in the distal edge of the second side panel 112 of the upper housing 11 and is disposed adjacent to the rear edge of the second side panel 112 of the upper housing 11. The extension panel 113 transversely protrudes from the distal edge of the second side panel 112 of the upper housing 11.

The base cover 12 is mounted under the upper housing 11 to form a mounting chamber defined between the base cover 12 and the upper housing 11. The base cover 12 has a rear, a front, a bottom panel 120, a first side panel 122, a second side panel 123, at least one engaging protrusion 124, two positioning protrusions 125, and a fastening panel 121.

The bottom panel 120 is bottom of the base cover 12, and is mounted under and securely attached to the extension panel 113 of the upper housing 11. Preferably, the extension panel 113 and the bottom 120 are securely attached to each other via fasteners, such as screws. The bottom panel 120 has a rear edge, a front edge, a first side edge, and a second side edge. The second side edge of the bottom panel 120 is opposite to the first side edge of the bottom panel 120.

The first side panel 122 of the base cover 12 protrudes up from the first side edge of the bottom panel 120, and corresponds in position to and is securely attached to the first side panel 111 of the upper housing 11. The first side panel 122 of the base cover 12 has an inner surface and at least one through hole 1221. The at least one through hole 1221 of the first side panel 122 of the base cover 12 corresponds in position to the at least one engaging recesses 1111 of the first side panel 111 of the upper housing 11. Preferably, the first side panel 111 of the upper housing 11 and the first side panel 122 of the base cover 12 are securely attached to each other via fasteners, such as screws.

The second side panel 123 of the base cover 12 protrudes up from the second side edge of the bottom panel 120, and corresponds in position to the second side panel 112 of the upper housing 11. A storing chamber is defined between the second side panel 112 of the upper housing 11 and the second side panel 123 of the base cover 12 for storing a power cord, a transformer, or the like.

The at least one engaging protrusion 124 protrudes transversely from the first side edge of the bottom panel 120, protrudes through the at least one through hole 1221 of the first side panel 122 of the base cover 12, and engages in the at least one engaging recess 1111 of the first side panel 111 of the upper housing 11.

The positioning protrusions 125 separately protrude up from the rear of the base cover 12, separately protrude up from the rear edge of the bottom panel 120, and are respectively disposed adjacent to the first side panel 122 of the base cover 12 and the second side panel 123 of the base cover 12. The positioning protrusion 125 that is disposed adjacent to the second side panel 123 of the base cover 12 engages in the mounting recess 1121 of the second side panel 112 of the upper housing 11 and abuts the second side panel 112 of the upper housing 11. Each of the positioning protrusions 125 has a distal end protruding transversely.

The fastening panel 121 is formed on the front of the base cover 12, and protrudes up from the front edge of the bottom panel 120 and has a threaded hole 1211.

In the preferred embodiment, the first side panel 111 of the upper housing 11 has two engaging recesses 1111 respectively disposed adjacent to a front edge of the first side panel 111 of the upper housing 11 and a rear edge of the first side panel 111 of the upper housing 11. The first side panel 122 of the base cover 12 has two through holes 1221 respectively corresponding in position to the engaging recesses 1111 of the first side panel 111 of the upper housing 11. The base cover 12 has two engaging protrusions 124 respectively protruding through the through holes 1221 of the first side panel 122 of the base cover 12, and respectively engaging in the engaging recesses 1111 of the first side panel 111 of the upper housing 11.

The connecting seat 13 is mounted in the mounting chamber on the base cover 12, and has a rear, a front, a connecting panel 130, a first panel 132, a second panel 133, at least one rear panel 134, two positioning recesses 135, and a front panel 131. The connecting panel 130 has two opposite side edges, a rear edge, a front edge, and multiple fastening holes 136. The first panel 132 and the second panel 133 of the connecting seat 13 respectively protrude down from the side edges of the connecting panel 130. The first panel 132 of the connecting seat 13 abuts the inner surface of the first side panel 122 of the base cover 12. The second panel 133 abuts the inner surface of the second side panel 112 of the upper housing 11.

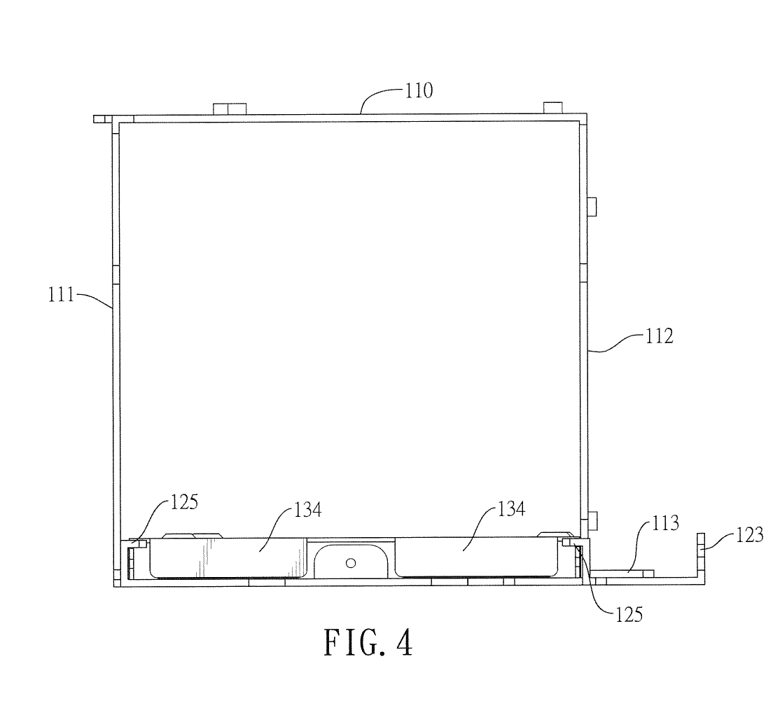

With further reference to FIG. 4, the at least one rear panel 134 protrudes down from the rear edge of the connecting panel 130.

The positioning recesses 135 are separately formed in the rear of the connecting seat 13, are separately formed in the rear edge of the connecting panel 130 of the connecting seat 13, and respectively correspond in position to and engage the positioning protrusions 125 of the base cover 12. When the positioning protrusions 125 of the base cover 12 engage in the positioning recesses 135 of the connecting seat 13, the distal ends of the positioning protrusions 125 and the connecting panel 130 of the connecting seat 13 forms a level surface.

Specifically, one of the positioning recesses 135 is formed through the first panel 132 and the at least one rear panel 134, and the other one of the positioning recesses 135 is formed through the second panel 133 and the at least one rear panel 134.

In the preferred embodiment, the connecting seat 13 has two rear panels 134 being spaced apart from each other, and the positioning recesses 135 are respectively formed through the two rear panels 134.

The front panel 131 is formed on the front of the connecting seat 13, protrudes down from the front edge of the connecting panel 130, and corresponds in position to and is detachably attached to the fastening panel 121 of the base cover 12. The front panel 131 has a mounting hole 1311 aligning with the threaded hole 1211 of the fastening panel 121. A fastener 100 is mounted through the mounting hole 1311 of the front panel 131 and the threaded hole 1211 of the fastening panel 121 to screw the front panel 131 and the fastening panel 121 together.

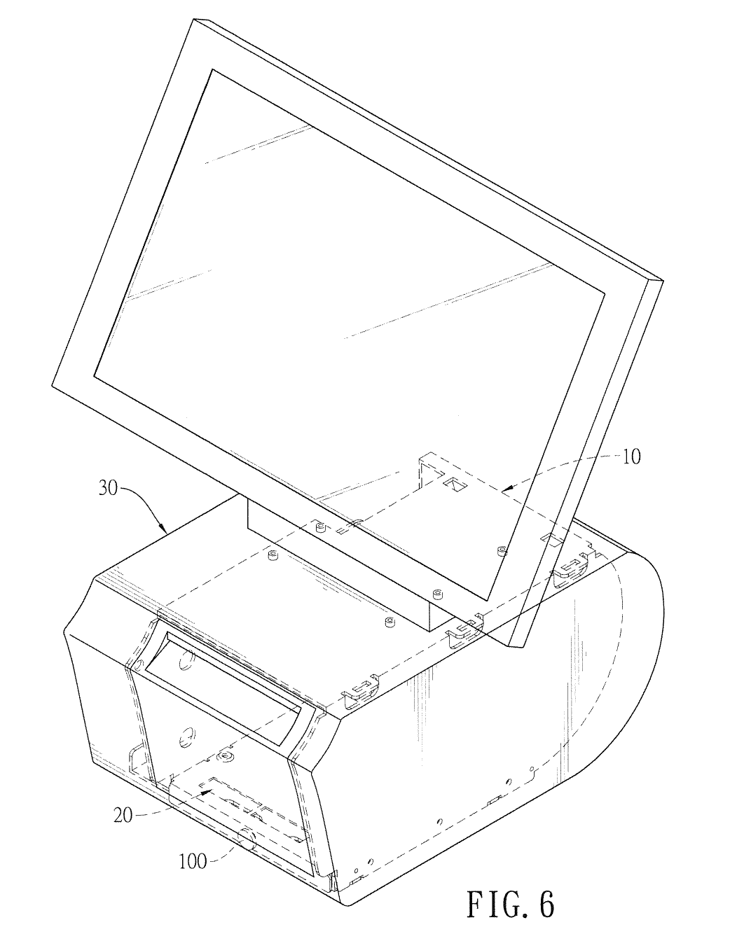

With further reference to FIGS. 5 and 6, when assembling the printer 20 and the mounting assembly, the printer 20 is mounted on the connecting seat 13 first. Multiple connectors are mounted through the fastening holes 136 of the connecting panel 130 of the connecting seat 13 and the printer 20 to attach the printer 20 to the connecting seat 13. Then the connecting seat 13 and the printer 20 are mounted into the mounting chamber defined between the base cover 12 and the upper housing 11. With the fastener 100 mounted through the mounting hole 1311 of the front panel 131 and the threaded hole 1211 of the fastening panel 121 to screw the front panel 131 and the fastening panel 121 together, the connecting seat 13 and the printer 20 are securely mounted in the mounting chamber and are packaged by the upper housing 11 and the base cover 12.

In the preferred embodiment, a cash register 30 comprises a touch screen display 31 and an installation chamber 32. The touch screen display 31 is used to show and to input transaction information. The installation chamber 32 is used for receiving the mounting assembly. Thus, the cash register 30, the mounting assembly, and the printer 20 are assembled together as an integral unit.

The mounting assembly for the printer 20 as described has the following advantages. As the printer 20 and a machine that cooperates with the printer 20 are assembled together as an integral unit by using the mounting assembly, the printer 20 can be stored easily. Moreover, space occupied by the printer 20 and the machine is greatly reduced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mounting assembly for a printer comprising:
an upper housing;
a base cover mounted under the upper housing to form a mounting chamber defined between the base cover and the upper housing, and the base cover having
two positioning protrusions separately protruding up from a rear of the base cover; and
a fastening panel formed on a front of the base cover; and
a connecting seat mounted in the mounting chamber on the base cover and having
two positioning recesses separately formed in a rear of the connecting seat, and respectively corresponding in position to and engaging the positioning protrusions of the base cover; and
a front panel formed on a front of the connecting seat, and corresponding in position to and detachably attached to the fastening panel of the base cover.

2. The mounting assembly as claimed in claim 1, wherein
the fastening panel of the base cover has a threaded hole;
the front panel of the connecting seat has a mounting hole aligning with the threaded hole of the fastening panel; and
a fastener is mounted through the mounting hole of the front panel and the threaded hole of the fastening panel to screw the front panel and the fastening panel together.

3. The mounting assembly as claimed in claim 1, wherein
the connecting seat further has
a connecting panel having two opposite side edges and a rear edge;
a first panel protruding down from one of the side edges of the connecting panel;
a second panel protruding down from the other one of the side edges of the connecting panel; and
at least one rear panel protruding down from the rear edge of the connecting panel;
one of the positioning recesses is formed in the rear edge of the connecting panel and through the first panel and the at least one rear panel, and the other one of the positioning recesses is formed in the rear edge of the connecting panel and through the second panel and the at least one rear panel; and
each of the positioning protrusions of the base cover has a distal end protruding transversely, and the distal ends of the positioning protrusions engage in the positioning recesses of the connecting seat.

4. The mounting assembly as claimed in claim 2, wherein
the connecting seat further has
a connecting panel having two opposite side edges and a rear edge;
a first panel protruding down from one of the side edges of the connecting panel;
a second panel protruding down from the other one of the side edges of the connecting panel; and
at least one rear panel protruding down from the rear edge of the connecting panel;
one of the positioning recesses is formed in the rear edge of the connecting panel and through the first panel and the at least one rear panel, and the other one of the positioning recesses is formed in the rear edge of the connecting panel and through the second panel and the at least one rear panel; and
each of the positioning protrusions of the base cover has a distal end protruding transversely, and the distal ends of the positioning protrusions engage in the positioning recesses of the connecting seat.

5. The mounting assembly as claimed in claim 3, wherein
the connecting panel of the connecting seat had multiple fastening holes;
the printer is mounted on the connecting seat; and
multiple connectors are mounted through the fastening holes of the connecting panel of the connecting seat and the printer to attach the printer to the connecting seat.

6. The mounting assembly as claimed in claim 4, wherein
the connecting panel of the connecting seat had multiple fastening holes;
the printer is mounted on the connecting seat; and
multiple connectors are mounted through the fastening holes of the connecting panel of the connecting seat and the printer to attach the printer to the connecting seat.

7. The mounting assembly as claimed in claim 1, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

8. The mounting assembly as claimed in claim 2, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

9. The mounting assembly as claimed in claim 3, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

10. The mounting assembly as claimed in claim 4, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

11. The mounting assembly as claimed in claim 5, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

12. The mounting assembly as claimed in claim 6, wherein
the upper housing has
a top panel having two opposite side edges;
a first side panel protruding down from one of the side edges of the top panel and having at least one engaging recess formed in a distal edge of the first side panel of the upper housing; and
a second side panel protruding down from the other one of the side edges of the top panel; and
the base cover further has
a bottom panel having
a first side edge; and
a second side edge being opposite to the first side edge of the bottom panel;
a first side panel protruding up from the first side edge of the bottom panel;
a second side panel protruding up from the second side edge of the bottom panel; and
at least one engaging protrusion protruding transversely from the first side edge of the bottom panel and engaging in the at least one engaging recess of the first side panel of the upper housing.

13. The mounting assembly as claimed in claim 7, wherein
the second side panel of the upper housing has a mounting recess formed in a distal edge of the second side panel of the upper housing and disposed adjacent to a rear edge of the second side panel of the upper housing; and
the positioning protrusions of the base cover are respectively disposed adjacent to the first side panel of the base cover and the second side panel of the base cover, and the positioning protrusion that is disposed adjacent to the second side panel of the base cover engages in the mounting recess of the second side panel of the upper housing.

14. The mounting assembly as claimed in claim 8, wherein
the second side panel of the upper housing has a mounting recess formed in a distal edge of the second side panel of the upper housing and disposed adjacent to a rear edge of the second side panel of the upper housing; and
the positioning protrusions of the base cover are respectively disposed adjacent to the first side panel of the base cover and the second side panel of the base cover, and the positioning protrusion that is disposed adjacent to the second side panel of the base cover engages in the mounting recess of the second side panel of the upper housing.

15. The mounting assembly as claimed in claim 9, wherein
the second side panel of the upper housing has a mounting recess formed in a distal edge of the second side panel of the upper housing and disposed adjacent to a rear edge of the second side panel of the upper housing; and
the positioning protrusions of the base cover are respectively disposed adjacent to the first side panel of the base cover and the second side panel of the base cover, and the positioning protrusion that is disposed adjacent to the second side panel of the base cover engages in the mounting recess of the second side panel of the upper housing.

16. The mounting assembly as claimed in claim 10, wherein
the second side panel of the upper housing has a mounting recess formed in a distal edge of the second side panel of the upper housing and disposed adjacent to a rear edge of the second side panel of the upper housing; and
the positioning protrusions of the base cover are respectively disposed adjacent to the first side panel of the base cover and the second side panel of the base cover, and the positioning protrusion that is disposed adjacent to the second side panel of the base cover engages in the mounting recess of the second side panel of the upper housing.

17. The mounting assembly as claimed in claim 13, wherein the upper housing further has an extension panel transversely protruding from the distal edge of the second side panel of the upper housing and mounted under and securely attached to the bottom panel of the base cover.

18. The mounting assembly as claimed in claim 14, wherein the upper housing further has an extension panel transversely protruding from the distal edge of the second side panel of the upper housing and mounted under and securely attached to the bottom panel of the base cover.

19. The mounting assembly as claimed in claim 15, wherein the upper housing further has an extension panel transversely protruding from the distal edge of the second side panel of the upper housing and mounted under and securely attached to the bottom panel of the base cover.

20. The mounting assembly as claimed in claim 16, wherein the upper housing further has an extension panel transversely protruding from the distal edge of the second side panel of the upper housing and mounted under and securely attached to the bottom panel of the base cover.
